(19) United States
(12) Patent Application Publication
(10) Pub. No.: US 2021/0097117 A1
(43) Pub. Date: Apr. 1, 2021

(54) EVENT-DRIVEN INTERNET OF THINGS SEARCH OPTIMIZATION

(71) Applicant: International Business Machines Corporation, Armonk, NY (US)

(72) Inventors: Robert Huntington Grant, Atlanta, GA (US); Craig M. Trim, Ventura, CA (US); Zachary A. Silverstein, Austin, TX (US); Shawn Doolen, Edgewater, CO (US)

(21) Appl. No.: 16/584,164

(22) Filed: Sep. 26, 2019

(51) Int. Cl. G06F 16/9535; G06F 16/9538; G06F 16/435; G06N 20/00

(52) U.S. Cl. CPC G06F 16/9535; G06N 20/00; G06F 16/435; G06F 16/9538

(57) ABSTRACT

A computer-implemented system and method comprises tagging media information obtained in response to a user action of a user, storing user event information regarding a further user action related to the tagged media information, and training a machine learning engine with the user event information and the tagged media information. The method further comprises capturing IoT data associated with the user, determining whether the captured IoT data meets a relevance threshold utilizing the machine learning engine, and responsive to meeting the relevance threshold, saving the captured IoT data as relevant captured data in an IoT relevant data store. The method further comprises receiving search criteria from the user to search for data meeting the search criteria, modifying the search criteria utilizing the machine learning engine and the user history, and returning search results for display on the user device based on the modified search criteria.

### BACKGROUND

Disclosed herein is a system and related method for event-driven Internet of Things (IoT) search optimization. With the connectedness of today's devices, it is very common to view or display media on a first device and search a second device for information on the media displaying on the first device. Frequently, this is media that might have been previously viewed or possibly sent to another person. People may wish to engage with others by, e.g., sending similar types of media to one another.

### SUMMARY

According to one aspect disclosed herein, a computer-implemented method comprises, in a user media interaction and learning phase, tagging, using a tagger, media information obtained in response to a user action of a user, storing user event information regarding a further user action related to the tagged media information, and training a machine learning engine with the user event information and the tagged media information. In an Internet of Things (IoT) capture phase, the method comprises capturing IoT data associated with the user, determining whether the captured IoT data meets a relevance threshold utilizing the machine learning engine, responsive to not meeting the relevance threshold, discarding the captured IoT data, and responsive to meeting the relevance threshold, saving the captured IoT data as relevant captured data in an IoT relevant data store. In a search improvement phase, the method comprises receiving search criteria from the user to search for data meeting the search criteria, modifying the search criteria utilizing the machine learning engine and the user history, and returning search results for display on the user device based on the modified search criteria.

According to another aspect disclosed herein, a system is provided, comprising a processor configured to, in a user media interaction and learning phase, tag, using a tagger, media information obtained in response to a user action of a user, store user event information regarding a further user action related to the tagged media information, and train a machine learning engine with the user event information and the tagged media information. The system, in an Internet of Things (IoT) capture phase, captures IoT data associated with the user, determines whether the captured IoT data meets a relevance threshold utilizing the machine learning engine, responsive to not meeting the relevance threshold, discards the captured IoT data, and responsive to meeting the relevance threshold, saves the captured IoT data as relevant captured data in an IoT relevant data store. The system, in a search improvement phase, receives search criteria from the user to search for data meeting the search criteria, modifies the search criteria utilizing the machine learning engine and the user history, and returns search results for display on the user device based on the modified search criteria.

Furthermore, embodiments may take the form of a related computer program product, accessible from a computer-usable or computer-readable medium providing program code for use, by, or in connection, with a computer or any instruction execution system. For the purpose of this description, a computer-usable or computer-readable medium may be any apparatus that may contain a mechanism for storing, communicating, propagating or transporting the program for use, by, or in connection, with the instruction execution system, apparatus, or device.

### BRIEF DESCRIPTION OF THE DRAWINGS

Various embodiments are described herein with reference to different subject-matter. In particular, some embodiments may be described with reference to methods, whereas other embodiments may be described with reference to apparatuses and systems. However, a person skilled in the art will gather from the above and the following description that, unless otherwise notified, in addition to any combination of features belonging to one type of subject-matter, also any combination between features relating to different subject-matter, in particular, between features of the methods, and features of the apparatuses and systems, are considered as to be disclosed within this document.

The aspects defined above, and further aspects disclosed herein, are apparent from the examples of one or more embodiments to be described hereinafter and are explained with reference to the examples of the one or more embodiments, but to which the invention is not limited. Various embodiments are described, by way of example only, and with reference to the following drawings:

FIG. 1 depicts a cloud computing environment according to an embodiment of the present invention.

FIG. 2 depicts abstraction model layers according to an embodiment of the present invention.

FIG. 3 is a block diagram of a DPS according to one or more embodiments disclosed herein.

FIG. 4A is a block diagram of one or more embodiments of a search optimization system, according to some implementations.

FIG. 4B is a block diagram of an example neural network, according to some implementations.

FIG. 5 is a table of an example user history database with user history records.

FIG. 6 is a flowchart of one or more embodiments of a process disclosed herein.

### DETAILED DESCRIPTION

In order to better locate information, particularly information associated with IoT media data that the user may have interacted with, a user's event history may be utilized, combined with meta-data associated with the IoT media data, to search for information that is relevant to the user. The system may thus use media meta-data and event history to establish search optimization in a data corpus involving IoT data sources that the user previously significantly (according to some threshold) interacted with.

Throughout this description, a use case involving a multimedia image or video data is used for illustrative purposes—however, the invention is not so limited and may be applied to any field involving media to which the user is exposed.

The following acronyms may be used below:
API application program interface
ARM advanced RISC machine
CD-ROM compact disc ROM
CMS content management system
CoD capacity on demand
CPU central processing unit
CUoD capacity upgrade on demand
DPS data processing system
DVD digital versatile disk
EPROM erasable programmable read-only memory
FPGA field-programmable gate arrays
HA high availability
IaaS infrastructure as a service
I/O input/output
IPL initial program load
ISP Internet service provider
ISA instruction-set-architecture
LAN local-area network
LPAR logical partition
PaaS platform as a service
PDA personal digital assistant
PLA programmable logic arrays
RAM random access memory
RISC reduced instruction set computer
ROM read-only memory
SaaS software as a service
SLA service level agreement
SRAM static random-access memory
WAN wide-area network

### Cloud Computing in General

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as Follows

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

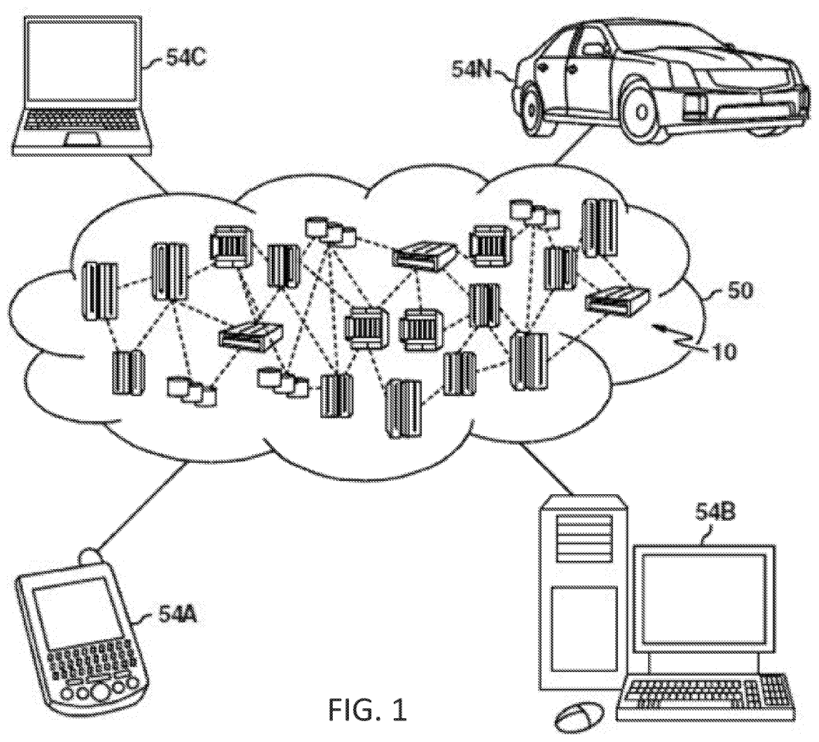

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

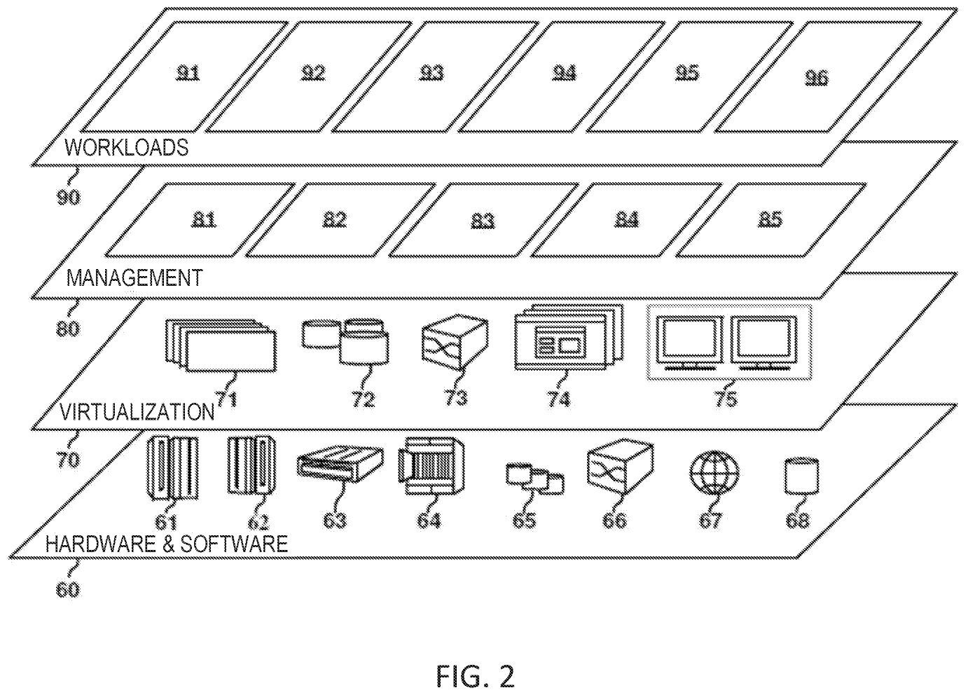

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and mobile desktop 96.

### Data Processing System in General

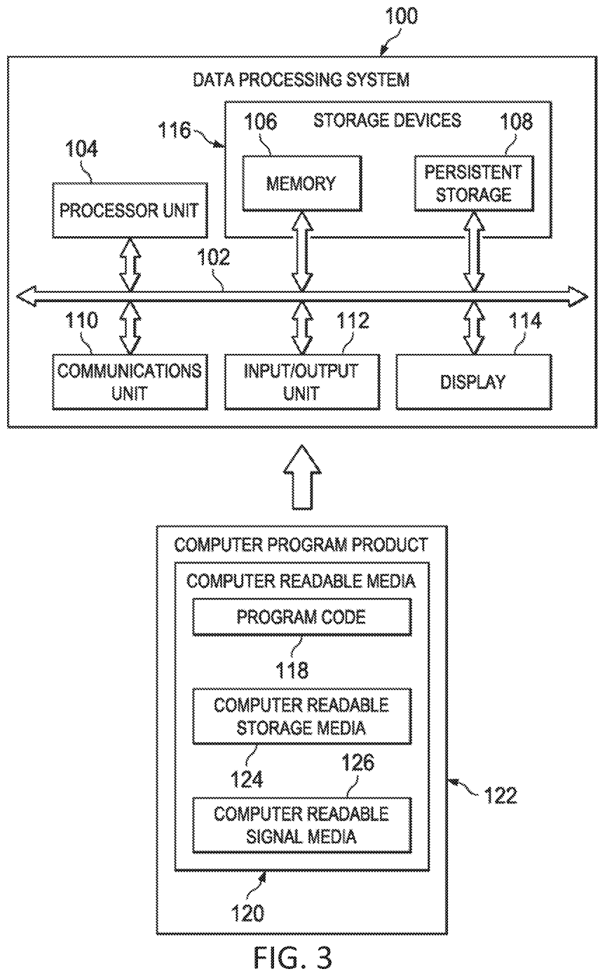

FIG. 3 is a block diagram of an example DPS according to one or more embodiments. The DPS may be used as a cloud computing node 10. In this illustrative example, the DPS 100 may include communications bus 102, which may provide communications between a processor unit 104, a memory 106, persistent storage 108, a communications unit 110, an I/O unit 112, and a display 114.

The processor unit 104 serves to execute instructions for software that may be loaded into the memory 106. The processor unit 104 may be a number of processors, a multi-core processor, or some other type of processor, depending on the particular implementation. A number, as used herein with reference to an item, means one or more items. Further, the processor unit 104 may be implemented using a number of heterogeneous processor systems in which a main processor is present with secondary processors on a single chip. As another illustrative example, the processor unit 104 may be a symmetric multi-processor system containing multiple processors of the same type.

The memory 106 and persistent storage 108 are examples of storage devices 116. A storage device may be any piece of hardware that is capable of storing information, such as, for example without limitation, data, program code in functional form, and/or other suitable information either on a temporary basis and/or a permanent basis. The memory 106, in these examples, may be, for example, a random access memory or any other suitable volatile or non-volatile storage device. The persistent storage 108 may take various forms depending on the particular implementation.

For example, the persistent storage 108 may contain one or more components or devices. For example, the persistent storage 108 may be a hard drive, a flash memory, a rewritable optical disk, a rewritable magnetic tape, or some combination of the above. The media used by the persistent storage 108 also may be removable. For example, a removable hard drive may be used for the persistent storage 108.

The communications unit 110 in these examples may provide for communications with other DPSs or devices. In these examples, the communications unit 110 is a network interface card. The communications unit 110 may provide communications through the use of either or both physical and wireless communications links.

The input/output unit 112 may allow for input and output of data with other devices that may be connected to the DPS 100. For example, the input/output unit 112 may provide a connection for user input through a keyboard, a mouse, and/or some other suitable input device. Further, the input/output unit 112 may send output to a printer. The display 114 may provide a mechanism to display information to a user.

Instructions for the operating system, applications and/or programs may be located in the storage devices 116, which are in communication with the processor unit 104 through the communications bus 102. In these illustrative examples, the instructions are in a functional form on the persistent storage 108. These instructions may be loaded into the memory 106 for execution by the processor unit 104. The processes of the different embodiments may be performed by the processor unit 104 using computer implemented instructions, which may be located in a memory, such as the memory 106.

These instructions are referred to as program code, computer usable program code, or computer readable program code that may be read and executed by a processor in the processor unit 104. The program code in the different embodiments may be embodied on different physical or tangible computer readable media, such as the memory 106 or the persistent storage 108.

The program code 118 may be located in a functional form on the computer readable media 120 that is selectively removable and may be loaded onto or transferred to the DPS 100 for execution by the processor unit 104. The program code 118 and computer readable media 120 may form a computer program product 122 in these examples. In one example, the computer readable media 120 may be computer readable storage media 124 or computer readable signal media 126. Computer readable storage media 124 may include, for example, an optical or magnetic disk that is inserted or placed into a drive or other device that is part of the persistent storage 108 for transfer onto a storage device, such as a hard drive, that is part of the persistent storage 108. The computer readable storage media 124 also may take the form of a persistent storage, such as a hard drive, a thumb drive, or a flash memory, that is connected to the DPS 100. In some instances, the computer readable storage media 124 may not be removable from the DPS 100.

Alternatively, the program code 118 may be transferred to the DPS 100 using the computer readable signal media 126. The computer readable signal media 126 may be, for example, a propagated data signal containing the program code 118. For example, the computer readable signal media 126 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, the program code 118 may be downloaded over a network to the persistent storage 108 from another device or DPS through the computer readable signal media 126 for use within the DPS 100. For instance, program code stored in a computer readable storage medium in a server DPS may be downloaded over a network from the server to the DPS 100. The DPS providing the program code 118 may be a server computer, a client computer, or some other device capable of storing and transmitting the program code 118.

The different components illustrated for the DPS 100 are not meant to provide architectural limitations to the manner in which different embodiments may be implemented. The different illustrative embodiments may be implemented in a DPS including components in addition to or in place of those illustrated for the DPS 100. Other components shown in FIG. 1

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

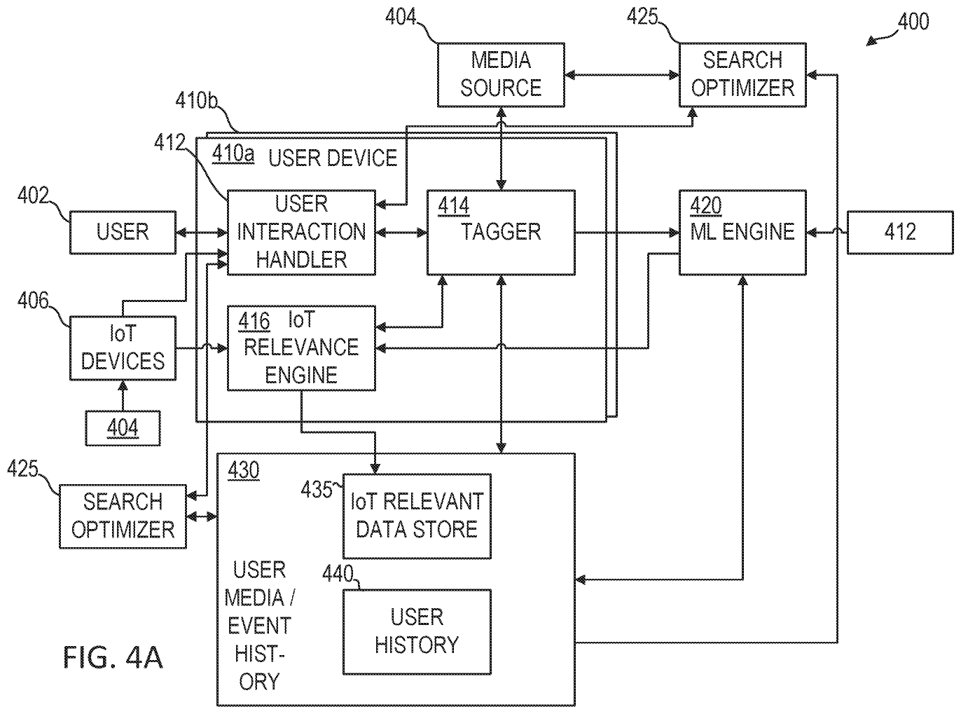

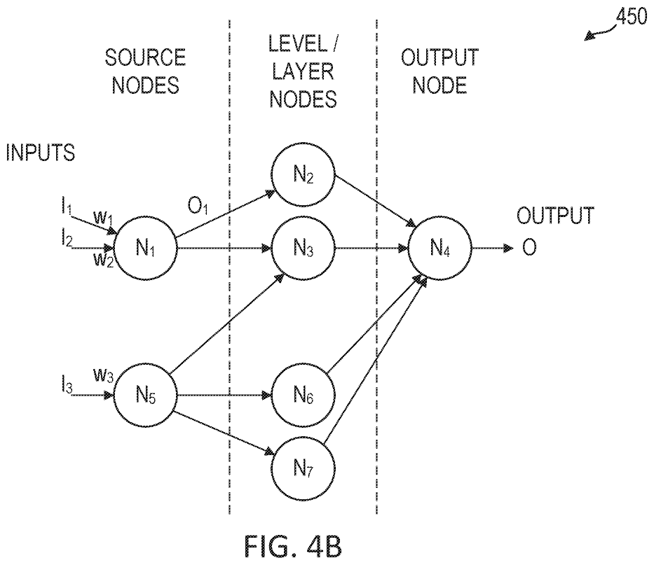

FIG. 4A is a block diagram of an example event-driven IoT search optimization system 400. A user 402 may interact with media content from a variety of media sources 404 via a user device(s) 410a, 410b (reference number 410 may be used to represent a first 410a and second 410b user device) comprising a user interaction handler 412. The user device 410 may be a DPS 100, as described above, and may be in the form of a smart phone, personal computer (lap top, desk top), augmented or virtual reality device, or any other form of computing device associated with the user 402. The media sources 404 may include web-based, cloud. database. or any other sources of information available in a network infrastructure. The user interaction handler 412 may serve as an interface between the user 402 and the media source 404 providing the data, maintaining information about and possibly controlling, to some extent, the interaction. The user 402 may request information from, e.g., a web server as the media source 404, and the information that is retrieved in response to the request may be tagged by a tagger 414 that associates descriptive information about the received information.

The tagger 414 may create tags based on, e.g.: a) semantic processing of the received information content, b) context information (meta data) about the received information that may be obtained from any form of metadata source or deduced from a current context in which the inquiry is taking place or associated resources, and c) image- or audio-based recognition that may be performed on media-based content of the received information.

### Use Case

The following use case, and its embellishments, are used below to illustrate various aspects discussed herein. Rob is an avid social media user. Although Rob's favorite baseball team is the Braves, he frequently sends articles and pictures and social media posts about the Mets® baseball team to his friend Zach.

While Rob is spending some time in Times Square, he sees a new funny advertisement in the form of an image on a large overhead display (media source 404) in Times Square. The image is an advertisement for a baseball team, the Mets®, involving horses and humor, which he spends some time viewing. One or more IoT devices 406 associated with Rob and/or his mobile device (first user device 410a), such as his smartphone, may detect and/or record the advertisement and/or information related to the advertisement Rob is viewing and detect the amount of time Rob spends viewing it. Information about what Rob viewed, the form in which it was viewed, and the amount of time Rob spent viewing it may all be saved in a history area (IoT relevant data store 435), provided it meets some threshold of significance (via the IoT relevance engine 416) based on Rob's interaction with the information. In this case, a ten-second gaze at the overhead display 406 is considered to meet the threshold of significance.

Rob subsequently returns to his apartment and watches a Yankees® game on his television and decides to try to find, using his laptop (second user device 410b) the funny Mets® advertisement he viewed earlier in the day to send to his friend Zach by doing a search on his laptop computer. However, Rob inadvertently types in the team “Yankees®” and “horses” when he meant to type in “Mets®” as one of the search terms for his search engine, intending to find the Mets® advertisement with the horses. The system determines that Rob has a high likelihood of wanting to send the advertisement involving the Mets® and horses that he saw earlier to his friend Zach, based on Rob's frequent patterns of behavior that are stored in the user media/event history store 430. Due the ambiguity (or incorrectness) of his search terms, with a normal search engine, the correct advertisement might not be located. However, the system is able to utilize Rob's patterns of behavior coupled with historically accessed context in order to create a search more likely to produce intended results.

Applying this use case to the system 400 illustrated in FIG. 4A, Rob is the user 402 who has historically accessed stories and advertisements related to the Mets® and emails such stories to Zach. The user interaction handler 412 may monitor information received from the user 402, such as Internet search requests, as well as information sent to the user 402. In the use case, if Rob performs a web-based search for Mets®, the request information may pass through the user interaction handler 412 to the tagger 414 which may identify the Mets® inquiry along with the information received from the media source(s) 404 based on the query. The query itself along with the results received from the media source 404 may be provided along with any of the tagged information to the machine learning engine 420 in, e.g., a training mode. In addition, the machine learning engine 420 may further obtain information from the user interaction handler 412 as to what Rob (the user) 402 does with the information received. For example, results from the media source 404 based on the search for “Mets®” that also contain a tag “humor” (directly from the content, metadata, or indirectly via parsed information) are frequently sent by Rob 402 to his friend Zach. The machine learning engine 420 thus associates data with “Mets®” and “humor” with “email Zach”. A large number of these types of patterns may be recognized by the machine learning engine 420, and these patterns may be trained until a statistically significant and relevant threshold for content interaction is consistent. The information obtained from the media source 404 may be stored in the user media/event history store 430 (in tagged or untagged form) for processing by the machine learning engine 420 as well.

The user 402 may further interact with various data sources that are IoT devices 406 having IoT feeds that are connected to the user device 410. The IoT devices 406 may include a wide variety of devices, such as other mobile devices, smart televisions, IoT beacons, geolocation devices, advertising devices, and any other device that incorporates IoT-related technology. The IoT device(s) 406 may be constantly interacting with the user device 410, providing a stream of IoT data (the stream of IoT data may also include data from the user device 410 to the respective IoT device 406). This data may be processed, e.g., in a manner as described above for data to or from the media source 404—e.g., its content may be semantically processed or may utilize image, audio, or other form of multimedia data processing, or associated metadata may be processed. Also, inferences may be made as a part of the processing. The processed IoT data may, in some implementations, be tagged in a manner as described above as well. Additionally, an IoT relevance engine 416 may determine if each piece of content in the stream meets a predefined threshold of relevance (this may be done before and/or after its processing from the IoT device 406, and may include information such as URL data, image, video, audio, AR/VR, and other forms of multimedia data). If the threshold of relevance is met, the IoT relevant data may be stored in an IoT relevant data store 435.

The IoT devices 406 and the other media sources 404 may be viewed as different sources of information (i.e., inputs). As such, both sources of data may utilize the tagger and have user interaction events associated with them. In some embodiments, the machine learning engine 420 may utilize both sources of data as inputs for classifying relevant search data. When a user performs a search that is modified, that modified search may be beneficial in searching other media sources in addition to the IoT relevant data store 435.

Returning to the use case described above, the user device 410 may have associated itself with an IoT device 406 at a dining establishment frequented by the user 402. The IoT device 406 may have captured a direction of Rob's gaze and determined that Rob was looking at the advertisement on the large overhead display, and then determined the content (the funny Mets® advertisement) that Rob was viewing. It may further have collected information on aspects of Rob's reaction to the advertisement (the length of him staring at it, e.g., ten seconds, a smile on his face via expression recognition, etc.) All of this information may have been taken into account for the IoT relevance engine 416 to determine that the content of the advertisement met the threshold of relevance such that this advertisement should be included in the IoT relevant data store 435.

The association of particular IoT devices 406 with the user device 410 may be made by the user 402 who may further establish various permissions as to the types of data that may be gathered and processed. When IoT devices 406 are associated with the user in some manner, data from these device 406 may be streamed to the user's devices 410 without the user expressly requesting the information. Thus, unlike data from a media source 404 that may be expressly and/or directly requested by the user 402 (e.g., in the form of a search request, click on a link, activation of an application, etc.), the data from the IoT devices 406 may represent a constant stream of information that presents itself to the user device 410 and that benefits from a filtering to determine relevance. The machine learning engine 420 may generate and store a persistent user history 440 in a memory of the user device 410 or a remote device, such as a server or cloud platform.

### Spreading Activation Algorithm

FIG. 4B is a block diagram of an example artificial neural network (ANN) 450. The ANN may utilize an extension to a spreading activation algorithm used to update the nodes to deal with the scenario of a time-based decay of information. Spreading activation is a model of working (short-term) memory that seeks to explain how the mind processes related ideas, especially semantic or verbal concepts. Spreading activation is described by a method for searching associative networks, biological and artificial neural networks, or semantic networks. The search process is initiated by labeling a set of source nodes with weights or “activation” and then iteratively propagating or “spreading” that activation out to other nodes linked to the source nodes. These “weights” may be real values that decay as activation propagates through the network. When the weights are discrete, this process may be referred to as marker passing. Activation may originate from alternate paths, identified by distinct markers, and terminate when two alternate paths reach the same node. Spreading activation may be applied here for information retrieval, using a network of nodes representing documents or information obtained from web-based and IoT-based sources of information and terms contained in those documents or sources of information.

The spreading activation theory may present an array of concepts as cognitive units, each comprising a node and its associated elements or characteristics, all connected together by edges, which may have a value representing a degree of connectedness between the nodes. A spreading activation network can be represented schematically, in a sort of web diagram with shorter lines between two nodes meaning the ideas are more closely related and will typically be associated more quickly to the original concept. The activation of pathways in the network has relates to how closely linked two concepts are by meaning, as well as how the network is primed.

A spreading activation algorithm may be represented using a directed graph that is populated by nodes[1 . . . N], each having an associated activation value A[i], which may be a real number in the range of [0.0 . . . 1.0]. A link[i, j] connects a source node[i] with a target node[j]. Each edge may have an associated weight W[i, j] that may be a real number in the range [0.0 . . . 1.0]. The involved parameters may include a firing threshold F that may be a real number in the range [0.0 . . . 1.0], and a decay factor D, that may be a real number in the range [0.0 . . . 1.0].

An example of a process for the spreading activation algorithm may be as follows:
a. Initialize the graph setting all activation values A[i] to zero. Set one or more origin nodes to an initial activation value greater than the firing threshold F (e.g., 1.0).
b. For each unfired node[i] in the graph having an activation value A[i] greater than the node firing threshold F:
c. For each link[i, j] connecting the source node[i] with target node[j], adjust A[j]=A[j]+(A[i]*W[i, j]*D), where D is the decay factor.
d. If a target node receives an adjustment to its activation value so that it would exceed 1.0, then set its new activation value to 1.0. Likewise maintain 0.0 as a lower bound on the target node's activation value, should it receive an adjustment to below 0.0.
e. Once a node has fired, it may not fire again (although in some embodiments, variations of the basic algorithm permit repeated firings and loops through the graph may be allowed).
f. Nodes receiving a new activation value that exceeds the firing threshold F are marked for firing on the next spreading activation cycle.
g. If activation originates from more than one node, a variation of the algorithm permits marker passing to distinguish the paths by which activation is spread over the graph.

The procedure terminates when either there are no more nodes to fire, or, in the case of marker passing from multiple origins, when a node is reached from more than one path. In some embodiments, variations of the algorithm that permit repeated node firings and activation loops in the graph terminate after a steady activation state, with respect to some delta, is reached, or when a maximum number of iterations is exceeded.

The ANN is represented by a plurality of nodes (N_{X}), each having an input and an output. The nodes may be organized into layers or levels. As shown in FIG. 4B, the ANN has three layers of nodes: source nodes, middle level/layer nodes, and an output node, although typically an ANN will have a significantly greater number of nodes and layers. Node N₁ in the example has two inputs I₁, I₂ which have corresponding weights w₁, w₂ respectively. The node N₁, acting as a neuron, may process the inputs according to the formula output O₁ of node N₁=f(w₁·I₁+w₂·I₂). The function f( ) is non-linear and may be called the activation function. This activation function may work with a sigmoid function, such as the standard logistic function:

$$S ( x ) = \frac{1}{1 + {e}^{- x}} = \frac{{e}^{x}}{{e}^{x} + 1} \qquad ( 1 )$$

The sigmoid function takes a real-valued input and maps it to a range between 0 and 1, and may be placed along the edge of each weight. Each level in the ANN may contain a set of phrase description nodes that the user has interacted with and that are activated by the user interaction (such as the gaze determinant). In the use case, the input I₁ may correspond to Rob's detecting gazing at the ad in Times Square, and the input I₂ may correspond to a duration of Rob's gaze, and the weighting elements may correspond to the significant of the gaze as well as the duration of the gaze in terms of its level of importance. The content of the media Rob looked at (the Mets® humorous ad with horses) may correspond to the third input I₃.

The weighting may be implemented as follows: each level in the ANN may contain a set of phrase description nodes that the user has interacted with activated by the gaze determinant (or, more generally, an importance indicator that describes the significance of the user interaction with the media) described above. The image or other media in turn may activate their terms using Z-score normalized activation weights in which phrases may correspond to one of the tags provided by the tagger 414. This then may suitably brings back higher-weighted images (or other media) immediately, and decays over time.

The decay over time addresses a natural phenomenon associated with memory, and addresses the question of what if the subject queried a day later . . . a month later . . . a year later. At some point, the system should decay its knowledge that subtly nudges and re-ranks results of decision-making over time. This decay over time may be implemented by applying the changes to the weightings of the edges in the ANN, and any form of decay (linear, exponential, etc.) may be applied. Decay parameters that control rates of decay over time may be empirically determined. A general equation for exponential decay that incorporates various parameters may be written as:

y=C(1−r)^{t} (3)

where:
y=final amount
C=initial amount
r=rate of change
t=time.

Information related to past user activity that is used as a basis for producing more relevant search results may benefit if it is allowed to degrade over time in a manner similar to the operation of human short-term memory. A method described herein utilizes a re-weighting of the edges using the gaze determinant (or any other importance indicator the indicates a degree of importance for the user event in acquiring the information) generated by the IoT devices. The gaze determinant is the amount of time the user spends viewing the add, but transformed using the sigmoid function according to Equation (1) described above.

The media content may be subject to additional processing—for example, the ANN may determine, through text recognition and image recognition on the video media presented in the ad, that this is an ad involving the Mets® as well as involving horses. It may also infer that humor is involved if a number of faces in the ad video are smiling/laughing via expression recognition. Further inputs may be provided that indicate Rob's response to other similar media. For example, historically, Rob emailed or texted Zach humorous Mets® ad, which may be incorporated into the ANN.

### User History 500

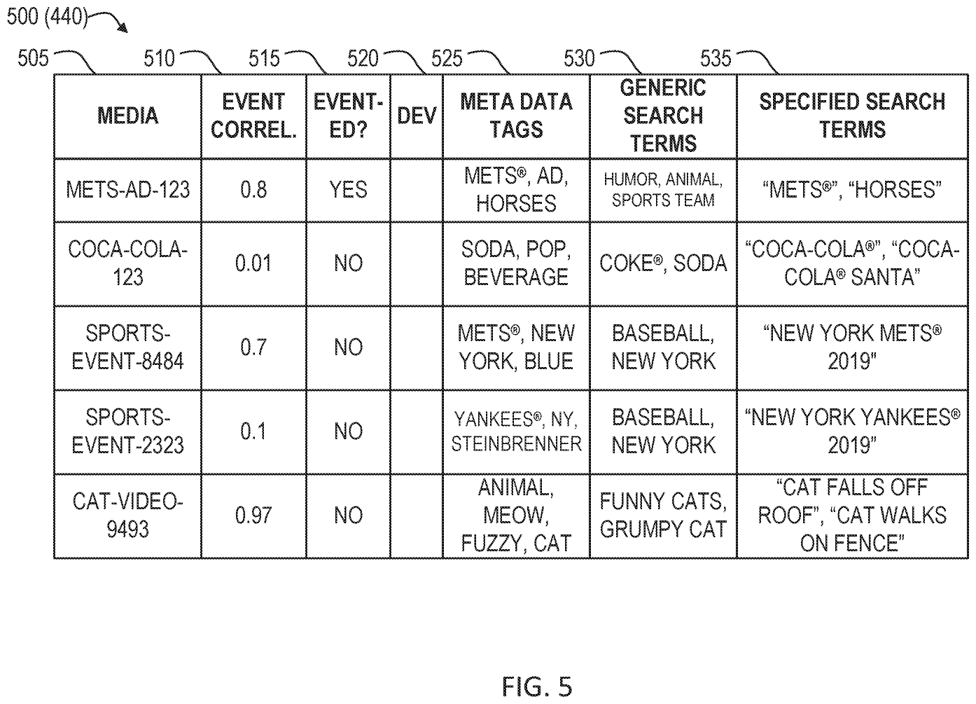

FIG. 5 is a table illustrating an example of a user history 500 (440), which is discussed in more detail below. The user 402 may execute a search, either through their own user device 410 or via a browser application on another device. Candidate media may be gathered based on a correlation between meta-data and generic search terms that exceed trained thresholds of the ANN. The user history 500 (440) may be stored in the user media/event history store 430.

The user history 500 may comprise one or more records, each record comprising fields that may include, for example, a media identifier 505 that may be an identifier used to locate a source of information previously accessed and possibly acted (evented) upon by the user 402. An event correlation field 510 may comprise a correlation value, such as the Pearson's correlation coefficient r, that indicates a strength of correlation between candidate media (for a user's search) from the IoT relevant data store 435 and meta-data and generic search terms that exceed the trained thresholds. The candidate media may be further iterated upon to determine if the candidate media has been evented on, as indicated by the evented indication field 515 and if the candidate media exceeds the event correlation threshold in the event correlation field 510. The event correlation field in essence answers the question “has the user historically evented on this?”, and is the value that may decay over time. Referring to the use case, the fact that Rob almost always emails or texts Zach funny Mets® ads provides a high event correlation between such events and media with similar/related content words or meta data tags. In some embodiments, the evented 515 field may be more sophisticated than a simple binary (yes/no) answer, but may contain other attributes and values. For example, “evented” may related to the sending of a text to Zach or an email to Craig.

The user history 500 may further comprise a device field 520 that identifies a device serving as the source of the media, as well as a meta data tag field 525 containing meta data tags for the media that were produced based on the content of the media by the tagger 414 or gathered during the course of the initial media access. The user history 500 may further comprise generic search term field 530 containing generic search terms that may be used to access the media of the IoT relevant data store 435, or to access other network-based media. The user history 500 may further comprise a specified search terms field 535 containing specific search terms that may be utilized to access the media.

In the use case, when Rob attempts to locate the funny Mets® ad with the horses to send to Zach, he inadvertently types in “Yankees®” and “horses” as the search terms. However, the system may, in addition to utilizing Rob's provided search terms, also utilize the generic search terms 530 to try to find the relevant media. Thus, the search may be modified to use more generalized search terms, substituting, e.g., “baseball team” for Yankees®, or even “sports team” for Yankees®. Similarly, if Rob had mistakenly typed “dogs” instead of “horses”, the same principle may be applied, e.g., substituting “animals” for “dogs”. The meta data tags 525 may also comprise generic tags associated with more specific tags, and thus, even an erroneous search for “Yankees®” and “dogs” may still retrieve media associated with “Mets®” and “horses”.

A degree of interaction may be determined to assess a relevant importance to the user of a particular set of information. This may be based, e.g., on a presumption that a greater amount interaction is indicative of a greater importance of that set of information to the user 402. The degree of interaction may be based on a variety of factors related to a user's 402 interaction with a particular data entity. Any mechanism for detecting interaction may be utilized. For example, interaction in the form of a touching interaction may be determined by sensors. A user 402 picks up a product in a store and either a contact sensor or imaging sensor, such as a camera, may determine the extent the user contacts the product package. Similarly, the user's 402 proximity to the data source and length of time at a particular proximity, and, e.g., an orientation of the body or head may be utilized to determine the degree of interaction.

One form of a degree of interaction is a gaze determinant, i.e., an amount of time the user 402 spends looking at the set of information. Different sensing devices may be utilized to determine a direction of a user's 402 gaze, such as a camera. Once the direction of a gaze is determined, an imaging device may be used to determine or estimate what the user's gaze is focused on, with some degree of accuracy. In the use case example, an IoT device 406 utilizes a camera to determine that Rob (the user 402) spent ten seconds staring at the Metz ad on the display screen, in contrast to the determination that he only spent one second staring at a billboard for an oil change. The system 400 may thus determine that the Metz ad is more significant than the oil change ad, due to the gaze time, and, depending on threshold values set, may store the Metz ad information in the IoT relevant data store 435.

### Process

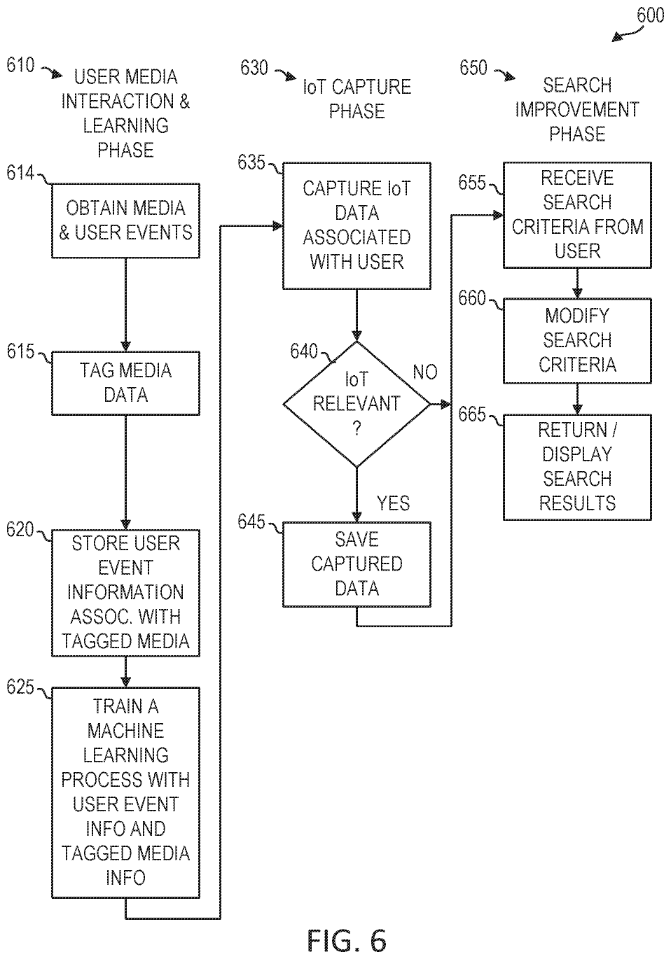

FIG. 6 is a flowchart that illustrates an example embodiment of a process 600 that may be divided into three phases: a user media interaction and learning phase 610, and IoT capture phase 630, and a search improvement phase 650. Although these phases are described below as taking place in a sequential manner, any combination of these phases may also operate concurrently.

In the user media interaction and learning phase 610, the system may, in operation 614, obtain media information directed to the user 402. Such media information may be search results based responsive to a search request according to a search criteria. It also may be the results, e.g., of a web page that is displayed responsive to clicking on a hyperlink or other user-based activity or “events”. For example, in the use case, Rob may enter the search terms “Mets®” and “humor” into the search engine, and receive results that include humorous ads and anecdotes related to the Mets®. The system may also receive information on user events, such as sending a link to another user. In the use case, Rob sending Zach a text message with a link to a web page with the humorous Mets® ad may be obtained as a user event. In operation 615, the search results may be tagged, based on the search results content and/or based on metadata associated with the search results. The tagged information along with a link to or actual retrieved results may be stored in the user media/event history 430.

In operation 620, the process may also store the user event information in the user media/event history 430, which may include activities that the user performs with respect to the retrieved information or that is associated with the tagged media, which may be combined and stored in the user history 440. For example (as described above), Rob may email and text various humorous Mets® articles (or related links) retrieved from his searches to Zach, depending on various criteria (e.g., they are not too long (e.g., <2000 words). Such events (e.g., email, texting, streaming, chatting, gazing, mouse clicking, or in any way acknowledging or interacting with presented information) along with metadata associated with the tagged media (including the tags themselves, criteria (such as length), etc.) may be provided as input data for a machine learning process that operates in a training mode, in operation 625, to establish relationships between media obtained/viewed and activities/events associated with these activities, as well as the tagged media information. Advantageously, by taking into account how the user has historically acted upon (evented) received information, better search results may be obtained by adjusting user-provided search criteria, as described herein.

In the IoT capture phase 630, the captured IoT data, such as the Mets® horse ad viewed by Rob in Times Square, is subject to an IoT relevance test in operation 640. In the use case, the IoT relevance test is performed by a threshold that combines both a duration of stare value, with, e.g., some weighting factor, and a viewing distance value, with, e.g., another weighting factor, and may utilize meta data and/or content data in order to determine relevance. For example, a ten-second stare (possibly combined with other criteria) may pass a threshold for relevance. In the case in which the IoT data is determined to be relevant (640: Y), in operation 645, the data may be saved to, e.g., the IoT relevant data store 435. Otherwise (640: N), the IoT data may be discarded. Advantageously, by creating a history of IoT-encountered media and enabling correlation to search optimization through event likelihood may result in more relevant search results being provided to the user.

In the search improvement phase 650, in operation 655, search criteria is received from the user. As the user executes a search, either through one of their devices (e.g., a smartphone, tablet, pad, personal computer, network IoT device, etc.) or a browser, the user's history may be parsed, which may include the IoT relevant data store 435 or other information in the user media/event history 430. Candidate media from the user media/event history 430 may be gathered based on the correlation to meta-data and generic search terms that exceed the trained thresholds. The candidate may be further iterated upon to determine: 1) if the media has been evented upon (evented indication field 515); and 2) if the media exceeds the event correlation threshold (field 510). If these are true, then the candidate record (e.g., the first data record shown in FIG. 5) may be selected to provide specific search terms to execute an entirely new search with new search terms which may be presented to the user. These search terms could be pre-defined or component of a principal component analysis (PCA).

In operation 660, the search criteria of the user is modified to retrieve results that may be more relevant to the user, even if those search results do not necessarily precisely meet the user's original search criteria. This modification may be based on the user's prior interactions with the media, as described above. The search improvement phase 650 may be implemented using a device associated with the user that differs from a device used to capture the IoT data in the IoT capture phase 630, which may further differ from the device used during the user media interaction and learning phase 610. By way of example, in the use case, in the user media interaction and learning phase, 610, Rob may typically obtain funny Mets® ads while surfing the Internet on his home computer. However, the capture of the funny Mets® ad with horses in Times Square during the IoT capture phase 630 was obtained using his cell phone device. Finally, during the search improvement phase 650, Rob uses his smart TV's Internet interface to search for the funny Mets® ad he saw earlier, and the return results may be displayed on his smart TV (or any other device associated with Rob). In this example, a server and/or cloud-based storage may be utilized to share the relevant information described above between Rob's various devices.

By way of example, in the use case, Rob is watching a Yankees® game when he remembers the funny Mets® advertisement earlier. However, in his search query, he inadvertently types in “Yankees®” and “horses” as the search term. The system may intercept this search and make modifications to it based on the information contained within the user media history 430, including the IoT relevant data store 435 and the user history 440. Given that Rob has recently been generating events in the form of emails and texts to Zach regarding Mets® and humor, the search optimizer may determine to modify the search to broaden it, narrow it, or broaden and narrow it in different ways. For example, it may broaden “Yankees®” to “baseball teams” and “horses” to “animals”. But it also may narrow the search in a different way by adding “humor” and/or “advertisement” to the search. This may make a search hit of what Rob originally intended far more likely, particularly given the fact that the IoT relevant data store 435 is included in the search corpus. As a result of the search modification, the funny Mets® ad with the horses from the IoT relevant data store 435 is returned as one of the search results, and Rob may then email or text it to Zach.

In some implementations, the search optimizer 425 only modifies searches directed to the IoT relevant data store 435, but in other implementations, the search optimizer 425 may modify searches directed to both the IoT relevant data store 435 as well as other media sources 404. Additionally, search results returned, in operation 665, from the modified search may be handled the same as any other user search in operation, e.g., the results of the search may be tagged in operation 615, stored in the user media history 430, and used to train the machine learning engine 420.

Other variations and embodiments may be provided. For example, in some embodiments, the new/modified search could be based on pre-defined search terms for respective media. For example, by knowing a user's residence address, their home baseball team may be pre-defined as a search term whenever a baseball team or baseball-related topics are involved. In this way, a relevance of certain terms, such as the home baseball team, may be presumed, at least initially.

In some embodiments, thresholds may be set based on the ambiguity of the initial search to execute a secondary search. For example, if a search just included the phrase “baseball team”, the amount of results from the search may be excessive. The system may determine that “baseball team” is too ambiguous, e.g., based on a large number of results returned or a large number of different baseball teams in the results returned. In this case, the system may attempt to construct a second search with baseball teams more likely to be of relevance from the user. For example, the user's home baseball team, if it can be determined, may be added as a search term in the secondary search, or, the user's historical discussions or other activities about specific baseball teams may be utilized to produce a search with more specific team information may be provided. In some embodiments, the generated search may be made narrow enough to ensure recent media (e.g., the Mets® horse advertisement) is included in the displayed results or increase the search such that it is only displayed in subsequent views. With this approach, a more flexible search may be performed that, e.g., may be of more utility to the use than prior searching systems.

### Computer Technology and Computer Readable Media

The one or more embodiments disclosed herein accordingly provide an improvement to computer technology. For example, an improvement to a search engine allows for a more efficient and effective search for information by the user. The ability to access stored information with which the user has interacted with in some manner, and allowing the weighting of the importance of this information to decay over time beneficially improves the operation of the search and benefits the user in that more pertinent results may be presented to the user.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method, comprising:
in a user media interaction and learning phase:
tagging, using a tagger, media information obtained in response to a user action of a user;
storing user event information regarding a further user action related to the tagged media information; and
training a machine learning engine with the user event information and the tagged media information;
in an Internet of Things (IoT) capture phase:
capturing IoT data associated with the user;
determining whether the captured IoT data meets a relevance threshold utilizing the machine learning engine;
responsive to not meeting the relevance threshold, discarding the captured IoT data; and
responsive to meeting the relevance threshold, saving the captured IoT data as relevant captured data in an IoT relevant data store;
in a search improvement phase:
receiving search criteria from the user to search for data meeting the search criteria;
modifying the search criteria utilizing the machine learning engine and a user history; and
returning search results for display on a user device based on the modified search criteria.

2. The method of claim 1, wherein the machine learning engine comprises nodes representing phrases and weighted edges connecting the nodes.

3. The method of claim 2, further comprising utilizing a spreading activation algorithm to update the nodes.

4. The method of claim 2, further comprising modifying edge weightings using a decay function.

5. The method of claim 1, wherein the user event information comprises information related to communication between the user and another person.

6. The method of claim 5, wherein the communication is selected from the group consisting of an email, a text message, and a social media post.

7. The method of claim 1, wherein the IoT data comprises media content, media metadata, and user interaction with the media data.

8. The method of claim 7, wherein the user interaction with the media data comprises gaze determinant data.

9. The method of claim 1, further comprising searching within the IoT relevant data store using the modified search criteria.

10. The method of claim 1, further comprising storing the user event information in a persistent user history.

11. The method of claim 10, wherein the persistent user history comprises a media identifier, an event correlation field, an evented indication field, a device field, a meta data tags field, a generic search terms field, and a specified search terms field.

12. The method of claim 1, wherein the capturing of the IoT data is performed by a first device that is associated with the user, and the search results using the modified search criteria are displayed on a second device associated with the user that is not the first device.

13. A system, comprising:
a processor configured to:
in a user media interaction and learning phase:
tag, using a tagger, media information obtained in response to a user action of a user;
store user event information regarding a further user action related to the tagged media information; and
train a machine learning engine with the user event information and the tagged media information;
in an Internet of Things (IoT) capture phase:
capture IoT data associated with the user;
determine whether the captured IoT data meets a relevance threshold utilizing the machine learning engine;
responsive to not meeting the relevance threshold, discard the captured IoT data; and
responsive to meeting the relevance threshold, save the captured IoT data as relevant captured data in an IoT relevant data store;
in a search improvement phase:
receive search criteria from the user to search for data meeting the search criteria;
modify the search criteria utilizing the machine learning engine and a user history; and
return search results for display on a user device based on the modified search criteria.

14. The system of claim 13, wherein the machine learning engine comprises nodes representing phrases and weighted edges connecting the nodes.

15. The system of claim 14, wherein the processor is further configured to utilize a spreading activation algorithm to update the nodes.

16. The system of claim 14, wherein the processor is further configured to modify edge weightings using a decay function.

17. The system of claim 13, wherein:
the IoT data comprises media content, media metadata, and user interaction with the media data; and
the user interaction with the media data comprises gaze determinant data.

18. The system of claim 13, wherein the processor is further configured to search within the IoT relevant data store using the modified search criteria.

19. A computer program product comprising a computer readable storage medium having computer-readable program code embodied therewith to, when executed on a processor:
in a user media interaction and learning phase:
tag, using a tagger, media information obtained in response to a user action of a user;
store user event information regarding a further user action related to the tagged media information; and
train a machine learning engine with the user event information and the tagged media information;
in an Internet of Things (IoT) capture phase:
capture IoT data associated with the user;
determine whether the captured IoT data meets a relevance threshold utilizing the machine learning engine;
responsive to not meeting the relevance threshold, discard the captured IoT data; and
responsive to meeting the relevance threshold, save the captured IoT data as relevant captured data in an IoT relevant data store;
in a search improvement phase:
receive search criteria from the user to search for data meeting the search criteria;
modify the search criteria utilizing the machine learning engine and a user history; and
return search results for display on a user device based on the modified search criteria.

20. The computer program product of claim 19, wherein:
the machine learning engine comprises nodes representing phrases and weighted edges connecting the nodes; and
the program code is further configured to utilize a spreading activation algorithm to update the nodes and to modify edge weightings using a decay function.
